(19) United States
(12) Patent Application Publication
(10) Pub. No.: US 2024/0278452 A1
(43) Pub. Date: Aug. 22, 2024

(54) AUTOMATED CORE VENEER FEEDER AND STITCHER FOR MANUFACTURING PLYWOOD

(71) Applicant: Georgia-Pacific Wood Products LLC, Atlanta, GA (US)

(72) Inventor: JT Capps, Jr., Huntington, TX (US)

(21) Appl. No.: 18/568,854

(22) PCT Filed: Aug. 18, 2022
(86) PCT No.: PCT/IB2022/057763

§ 371 Date: Dec. 11, 2023

Related U.S. Application Data
(60) Provisional application No. 63/237,798, filed on Aug. 27, 2021.

(51) Int. Cl. B27D 1/06; B32B 37/12; B32B 37/16

(52) U.S. Cl. CPC B27D 1/06; B32B 37/1284; B32B 37/16; B32B 2317/16

(57) ABSTRACT

Systems and methods for manufacturing plywood are provided. Aspects include receiving a face sheet, the face sheet having a grain oriented in a first direction and applying a first layer of adhesive to the face sheet. Aspects also include placing one or more pieces of stitched core material on the first layer of adhesive, the one or more pieces of stitched core material having a grain oriented in a direction offset from the first direction. Aspects further include applying a second layer of adhesive to the one or more pieces of stitched core material and placing a back sheet on the second layer of adhesive. Aspects also include pressing the face sheet, the one or more pieces of stitched core material, and the back sheet in a heated press.

### CROSS-REFERENCE TO RELATED APPLICATIONS

The present application claims priority to and the benefit of U.S. Provisional Patent Application Ser. No. 63/237,798, filed Aug. 27, 2021; the entire contents of which as are hereby incorporated by reference herein.

### BACKGROUND

### Related Field

The present invention generally relates to the field of plywood manufacturing, and more specifically to an automated core veneer feeder and an automated core veneer stitcher and/or taper for manufacturing plywood.

### Related Art

Plywood consists of three basic components, a face sheet, a back sheet, and a core material, also referred to as a cross band. The core material is disposed in between the face sheet and the back sheet and is typically laid such that the grain of the core material is offset from the grain of the face sheet and back sheet. Conventionally, plywood is thus made, at least in part, by manually placing one or more layers of core material in between the face sheet and the back sheet.

In some applications, at least one layer of the core material is made of multiple pieces of veneer that are smaller than the face and back sheet in at least one dimension. Currently, in these applications, the smaller pieces of veneer must be manually placed on either the face or back sheet by an operator. The operator ensures that the individual veneer pieces are precisely placed relative to one another and the face and back sheet with no laps or gaps between the pieces of veneers. This process is not only labor-intensive, but it also limits the speed at which the plywood can be manufactured. Difficulties with retention of the individual veneer pieces in the specific orientation and positions, during the assembly process, also contribute to labor costs and time delays.

### BRIEF SUMMARY

According to various embodiments of the present disclosure, a method for manufacturing plywood is provided. The method includes receiving a face sheet, the face sheet having a grain oriented in a first direction and applying a first layer of adhesive to the face sheet. The method also includes placing one or more pieces of stitched core material on the first layer of adhesive, the one or more pieces of stitched core material having a grain oriented in a direction offset from the first direction. The method further includes applying a second layer of adhesive to the one or more pieces of stitched core material and placing a back sheet on the second layer of adhesive. The method also includes pressing the face sheet, the one or more pieces of stitched core material, and the back sheet in a heated press.

According to another embodiment of the present disclosure, a method for creating stitched core material for manufacturing plywood is provided. The method includes receiving a plurality of pieces of green core veneers on a conveyor and crowding the plurality of pieces of green core veneers by an automated core veneer crowder disposed on the conveyor. The method also includes creating a continuous sheet of green core veneers by stitching the crowded plurality of pieces of green core veneers together by an automated core veneer stitcher and cutting the continuous sheet of green core veneers into a plurality of sheets of core material that each have a fixed width.

According to a further embodiment of the present disclosure, a piece of plywood is provided. The piece of plywood includes a face sheet of having a first width, a first length and a grain oriented in a first direction is provided. The piece of plywood also includes a back sheet having the first width, the first length and a grain oriented in the first direction and two pieces of stitched core material disposed between the face sheet and the back sheet, each of the two pieces of stitched core material having a grain oriented in a direction offset from the first direction, a length equal to half of the first length and a width equal to the first width.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIGS. 1A, 1B, and 1C are perspective views illustrating an automated system for creating core material for plywood manufacturing in accordance with an exemplary embodiment;

FIG. 2 is a block diagram illustrating an automated system for plywood manufacturing in accordance with an exemplary embodiment;

FIG. 3 is a block diagram illustrating an automated core veneer crowder in accordance with an exemplary embodiment;

FIG. 4 is a block diagram illustrating an automated core veneer stitcher in accordance with an exemplary embodiment;

FIG. 5 is a flow diagram illustrating a method for creating core material for plywood manufacturing in accordance with an exemplary embodiment;

FIG. 6 is a flow diagram illustrating a method for plywood manufacturing in accordance with an exemplary embodiment;

FIG. 7A is a cross-sectional view of plywood manufactured in accordance with an exemplary embodiment;

FIG. 7B is an exploded view of plywood manufactured in accordance with an exemplary embodiment; and

FIG. 7C is a cross-sectional view of a core layer of plywood manufactured in accordance with an exemplary embodiment that includes application of tape to the stitching placed thereon.

### DETAILED DESCRIPTION OF VARIOUS EMBODIMENTS

The invention is described in detail below with reference to the figures for purposes of illustration only. Modification to various embodiments illustrated within the spirit and scope of the present invention will be readily apparent to one of skill in the art.

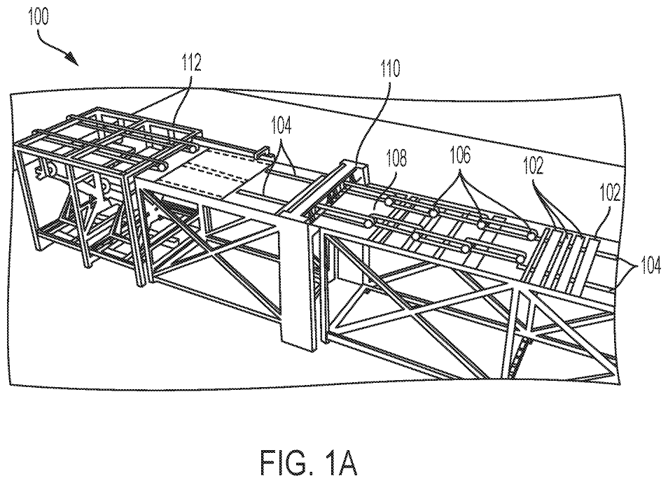

Referring now to FIGS. 1A, 1B, and 1C, a system 100 for creating core material for plywood manufacturing in accordance with an exemplary embodiment is shown. As illustrated, the system 100 includes a main conveyor 104 which extends through the system 100. The main conveyor 104 is configured to receive and move pieces of core veneer 102 to an automated core crowder that utilizes one or more actuators 106 to adjust the alignment of the pieces of core veneer 102 as needed. In exemplary embodiments, the actuators 106 ensure that there are no gaps between the adjacent pieces of core veneer 102 and that the adjacent pieces of core veneer 102 do not overlap. Once the pieces of core veneer 102 have passed through the automated core crowder, the crowded core veneers 108 enter an automated core veneer stitcher 110 that stitches the crowded core veneers 108 together to form a continuous sheet of stitched core veneer. In exemplary embodiments, the pieces of core veneer 102 are green veneers, which are pieces of veneers that have not been dried.

The automated core veneer stitcher 110 includes a plurality of stitching devices 114 that are configured to stitch together the crowded core veneers 108. In one embodiment, as best shown in FIG. 1B, the automated core veneer stitcher 110 may include four stitching devices 114. In one embodiment, the pieces of core veneer 102 have a length of eight feet and have varying widths. In this embodiment, the stitching devices 114 are disposed two inches from each end of the crowded core veneers 108 and two inches offset from the center of the crowded core veneers 108. In other words, measuring from one end of the crowded core veneers 108, the stitching devices are located at 2, 46, 50, and 94 inches.

In other embodiments, the automated core veneer stitcher 110 may have fewer or greater than four stitching devices 114, for example between two and eight stitching devices. In these and still other embodiments, the stitching devices 114 may be disposed fewer or greater than two inches from each end of the crowded core veneers 108 and fewer or greater than two inches from the center of the crowded core veneers. For example, the stitching devices 114 may be disposed between one and four inches from each end of the crowded core veneers 108 and likewise relative to the center thereof. In still other embodiments, the stitching devices 114 may be disposed a distance from each end of the crowded core veneers that is different from the distance offset from the center. In certain embodiments, the stitching devices 114 may be evenly disposed across and between the ends the crowded core veneers; in other embodiments, uneven or discontinuous positioning may be desirable, dependent at least in part upon cutting parameters, as described in further detail herein-below. Any of a various of combinations of these options may be envisioned, dependent upon desired applications of the plywood formed from the crowded core veneers 108, as described in further detail herein-below.

In exemplary embodiments, after the crowded core veneers 108 have been stitched together, a continuous sheet of stitched core veneer is cut into sections of core material having a desired width by a cutting device 116. In one embodiment, the desired width is four feet wide. In one embodiment, the cutting device 116 is a guillotine-type cutting device that is configured to slice the continuous sheet of stitched core veneer into four-foot-wide sections of stitched core veneer 118. As best illustrated in FIG. 1C, the stitched core veneer 118 sections each include four rows of continuous stitches 120. In one embodiment, the stitched core veneer 118 sections are cut into half by a cutting device 122, such as a circular saw, producing two pieces of stitched core veneer 118 that have a length and width of four feet. Next, the pieces of stitched core veneer 118 are placed into stacks by an automated stacker 124.

Remaining with FIG. 1C, it should be understood that in other embodiments, the desired cut width may be other than four feet wide. In these and still other embodiments, two or more cutting devices 122 may be provided, so as to produce three or more pieces of stitched core veneer 118, as may be desirable. In these embodiments, the location of the stitching devices 114 may be disposed at specific intervals appropriate to facilitate cutting of the stitched core veneer 118 into appropriate sizes such that at least two opposing edges of the cut core veneer retain stitches adjacent thereto. In any of these and still other embodiments, more or less than four rows of continuous stitches 120 may be provided; one or more discontinuities in one or more of the stitches may also be present, as desirable for taping or otherwise, as described below. In any of these and still other embodiments, the cutting device 122 may be any device capable of cutting a core veneer panel.

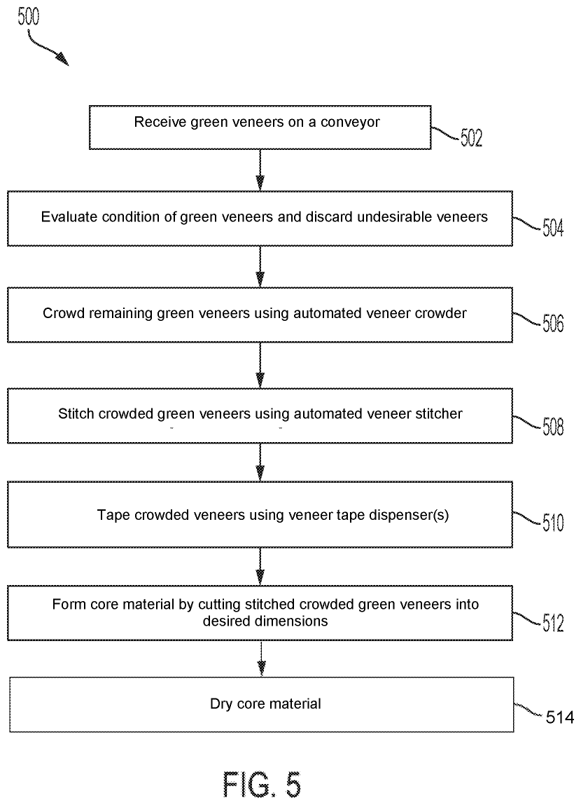

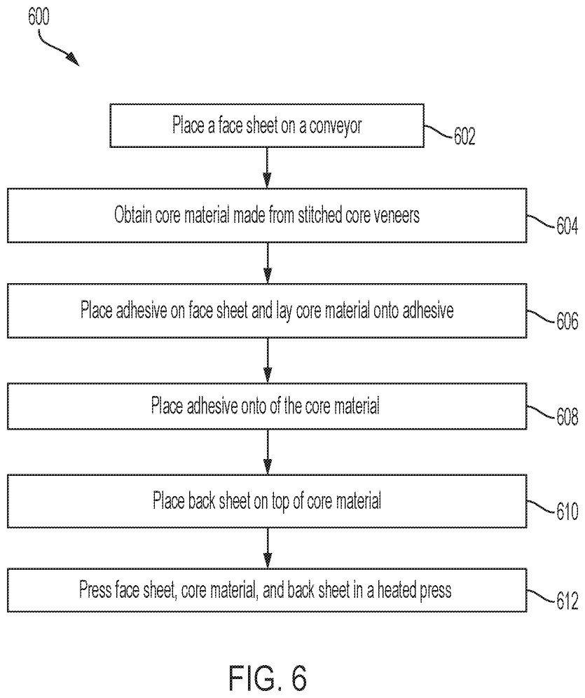

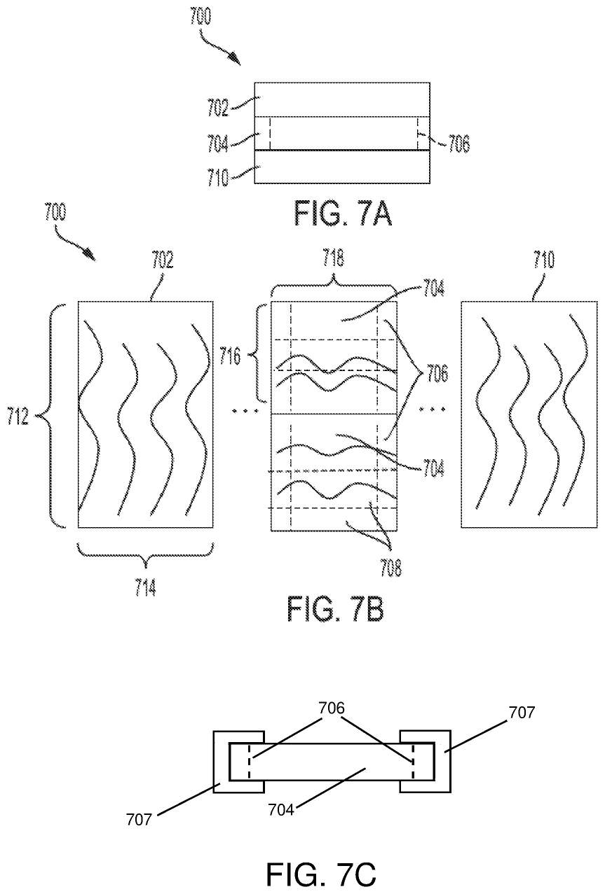

With reference again to FIG. 1C, illustrated thereon also are a plurality of tape dispensers 123 (not illustrated in FIGS. 1A-B only for purposes of clarity in those drawings). According to various embodiments, the tape dispensers 123 may be positioned along at least one edge of the stitched core veneer 118, whereby through dispensing of tape therefrom one or more strings along the stitches may be covered and retained in place by the tape. Reference is also made briefly to FIG. 7C, wherein a cross-sectional view of the core material 704 is illustrated with its provided stitches 706 (see discussion in further detail herein-below of this and related FIGS. 7A-B). As illustrated in this figure, dispensed tape 707 may be wrapped around one or more ends of the core material 704, so that one or both surfaces or sides of the stitch are covered and protected, so as to prevent delamination, unravelling, or the like.

As illustrated in FIG. 1C, the tape dispensers 123 may be spaced intermittently along at least one end of the stitched core veneer 118. Although not numbered in this figure, corresponding tape dispensers 123 may also be spaced intermittently along the opposing end of the stitched core veneer 118. In at least the illustrated embodiment, the tape dispensers 123 are located adjacent the cutting device 122; in these and other embodiments, though, the taper dispensers 123 may be located at any position intermediate the cutting device 122 and the stitching devices 114. In still other embodiments, one or more tape dispensers (not illustrated) may be further provided downstream of the cutting device 122, for taping of the center-positioned stitches (as described elsewhere herein).

It should be further understood that although FIG. 1C illustrates four tape dispensers 123 on each end of the stitched core veneer 118, fewer or greater than four tape dispensers may be provided in certain embodiments. For example, between one and eight tape dispensers may be provided along a single end of the stitched core veneer 118. A corresponding or a different number of tape dispensers may be provided along the opposing end of the stitched core veneer 118. In still other embodiments, the tape dispenser(s) 123 may be provided on only one end of the stitched core veneer 118. In at least one embodiment, the tape dispenser(s) 123 may be an 8-tape dispenser. In any of these and still other embodiments, it should be understood that a variety of tape dispensers and relative positionings thereof may be provided, so long as each is configured to secure the stitching string in such a way as to prevent and/or substantially minimize unravelling thereof.

In certain embodiments, the tape dispensed via the one or more tape dispensers 123 may be “green veneer” tape, as such is commonly known and understood to involve. The green veneer (or other configured) tape may be roughly ¾″ by 1.5″ so that it will fold over the top and bottom of the end securing the string of the stitches. The tape may, of course, be otherwise dimensioned, for example greater than 1.5″ so as to facilitate overlap of the tape with stitches that may be provided up to 2″ offset from an end of the stitched core veneer 118. The tape, beyond exemplary dimensions and ranges thereof considered sufficient for stitching or string overlap, is also specifically designed to adhere to wet veneer and to withstand dryer veneer temperatures up to at least 500 degrees Fahrenheit. Alternative tapes, dimensionally and characteristically, may also be utilized, as desirable for particular applications.

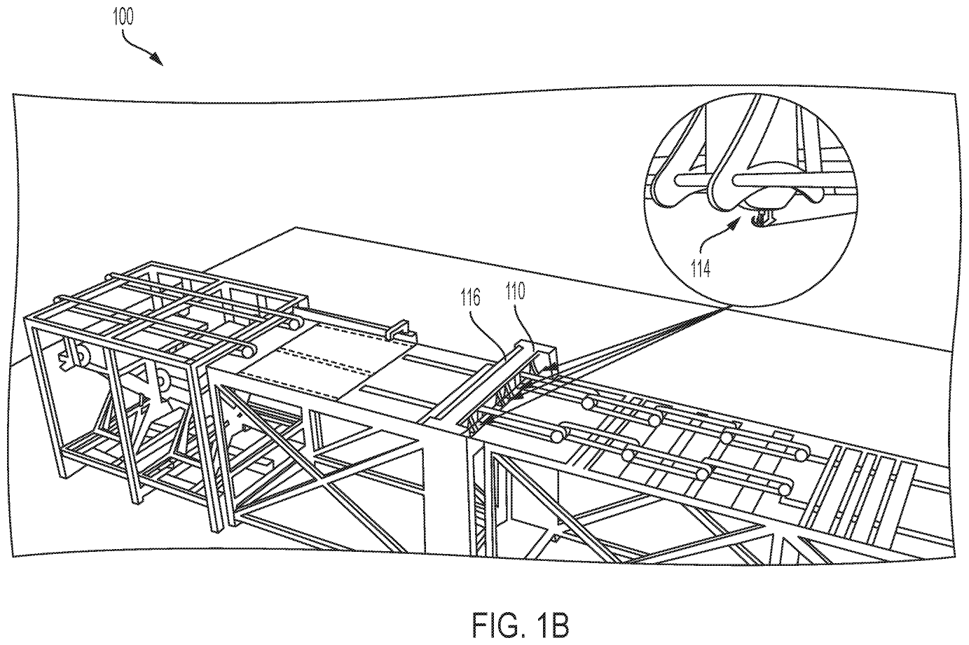

Referring now to FIG. 2, a block diagram of automated system 200 for plywood manufacturing in accordance with an exemplary embodiment is shown. As illustrated, the system 200 includes one or more processing systems 202. In exemplary embodiments, the processing systems 202 may include a simple processor such as an ASIC or FPGA or it may include a computer having a traditional microprocessor, memory, and a data storage device. The system 200 also includes an automated core veneer crowder 310, an automated core veneer stitcher 400 (which may include as a component thereof one or more tape dispenser(s) 123), an automated core veneer stacker 208, a core material drying system 210, a core material grading system 212, and an automated plywood assembly system 214. In exemplary embodiments, the processing systems 202 are configured to control the operation of one or more of the automated core veneer crowder 310, the automated core veneer stitcher 400, the automated core veneer stacker 208, the core material drying system 210, the core material grading system 212, and the automated plywood assembly system 214.

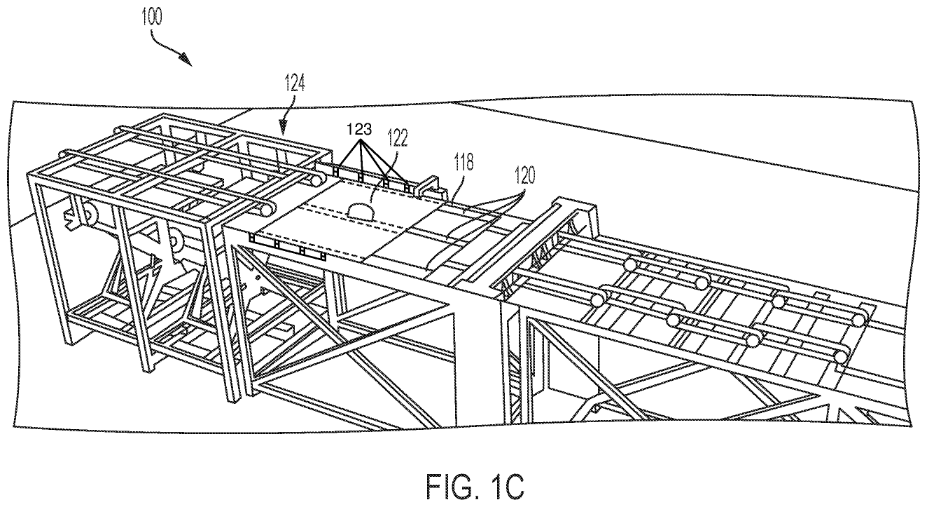

Referring now to FIG. 3, a block diagram of the automated core veneer crowder 310 in accordance with an exemplary embodiment is shown. The automated core veneer crowder 310 includes a processor 312, a vision system 314, sensors 322, and a veneer conveyor 316. The processor 312 may include a simple processor such as an ASIC or FPGA or it may include a traditional microprocessor. In exemplary embodiments, the processor 312 receives an input signal from the one or more sensors 322 and the vision system 314 and responsively calculates both the position and size of the pieces of core veneer on the veneer conveyor 316. In exemplary embodiments, the one or more sensors 322 are disposed along the veneer conveyor 316 and may include, but are not limited to, optical sensors, weight sensors, and the like. Based on the calculated size and position of the pieces of core veneer on the veneer conveyor, the processor 312 uses one or more of the forward actuators 318 and the lateral actuators 320 to individually move each of the pieces of core veneer on the veneer conveyor into the desired position. In exemplary embodiments, the forward actuators 318 are used to move an individual piece of veneer up and down the veneer conveyor and the lateral actuators 320 are used to move an individual piece of veneer from side to side on the veneer conveyor 316. In exemplary embodiments, the processor 312 controls one or more of the forward actuators 318 and lateral actuators 320 to crowd the pieces of core veneer and to ensure that there are no gaps between the adjacent pieces of core veneer and that the adjacent pieces of core veneer do not overlap.

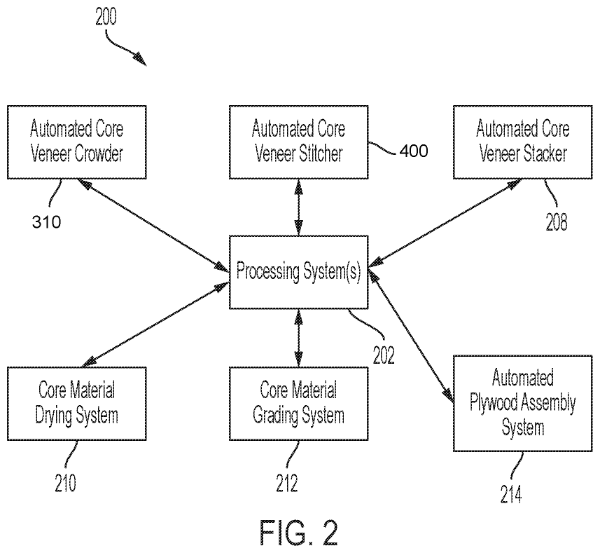

Referring now to FIG. 4, a block diagram of automated core veneer stitcher 400 in accordance with an exemplary embodiment is shown. The automated core veneer stitcher 400 includes a processor 402, one or more stitching devices 404, and a cutting device 406. The processor 402 may include a simple processor such as an ASIC or FPGA or it may include a traditional microprocessor. In exemplary embodiments, the processor 402 controls the operation of one or more stitching devices 404 and the cutting device 406. The stitching devices 404 are reciprocating sewing systems that include top and bottom sewing heads that are driven independently by different servo motors controlled by the processor 402. In exemplary embodiments, the stitching devices 404 are configured to use a ½″ thread that is able to able to withstand the heat of a veneer drying process, typically about 500 degrees F. In one embodiment, the stitching device 404 includes a needle made of hardened steel that are configured to puncture holes in the green veneers and pass a suitable thread through the green veneers. The taping devices 405 are tape dispensers that may be driven independently and/or automatically by different servo motors controlled by the processor 402. In exemplary embodiments, the taping devices 405 are configured to use a ¾″ tape cut at desired lengths (e.g., 1.5, 2.0, or greater inches), which tape is also able to adhere to wet veneer and to withstand the heat of a veneer drying process, typically about 500 degrees F. The cutting device 406 is configured to cut the continuous sheet of crowded and stitched core veneers into sheets having a desired width, such as four feet. In one embodiment, the cutting device 406 is a guillotine-type cutting device. In one embodiment, the cutting device 406 is mounted on a carriage that travels at the same rate of speed that the conveyor moves the veneers through the one or more stitching devices 404 to prevent impacts to sewing causing a jam and or a needle break.

Continuing with reference to FIG. 2, in exemplary embodiments, the automated core veneer stacker 208 is configured to receive core material, i.e., sheets of stitched core veneers, from the automated core veneer stitcher 400 and to place the core material into one or more stacks. The stacks of core material are then placed in the core material drying system 210, which is configured to dry the core material. In exemplary embodiments, the material drying system 210 includes a drying oven that is configured to reach approximately 500 degrees F. After the core material is dried, the dried core material is graded by the core material grading system 212. In exemplary embodiments, the core material grading system 212 includes a vision system that is configured to capture images of the dried core material and to assign a grade to the dried core material.

In exemplary embodiments, after the core material has been created, dried, and graded, an automated plywood assembly system 214 is configured to assembly plywood. The automated plywood assembly system 214 includes a conveyor system that receives a face sheet and applies an adhesive to the face sheet. Next, one or more pieces of core material are placed on top of the face sheet such that the grain of the core material is offset from the face sheet by 45 or 90 degrees. After the core material has been placed on the face sheet, an adhesive is added to the top of the core material and a back sheet is placed on the core material. Finally, the face sheet, core material, and back sheet are placed into a hot press, which forms the finished plywood.

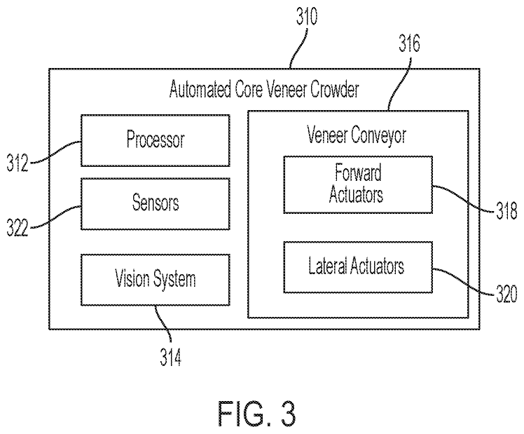

Referring now to FIG. 5, a flow diagram illustrating a method 500 for creating core material for plywood manufacturing in accordance with an exemplary embodiment is shown. The method 500 begins at block 502 by receiving green veneers on a conveyor. In exemplary embodiments, the green veneers have a standard length, such as eight feet, but have varying widths. Next, the condition of the green veneers are evaluated and undesirable veneers are discarded. In exemplary embodiments, an automated vision system is used to capture images of the green veneers and to assign a grade to each green veneer. Based on a determination that a grade of one of the green veneers is below a threshold level, one or more lateral actuators in the conveyor are activated to remove that green veneer from the conveyor.

Next, as shown at block 506, the method 500 includes crowding the green veneers using an automated veneer crowder. In exemplary embodiments, the automated veneer crowder adjusts the position of the green veneers on the conveyor to ensure that there are no gaps between the adjacent pieces of core veneer and that the adjacent pieces of core veneer do not overlap. The method 500 also includes stitching the crowded green veneers using an automated veneer stitcher, as shown at block 508. In exemplary embodiments, the automated veneer stitcher includes a plurality of stitching devices that are configured to continuously stitch across an entire width of the green veneers and to thereby join adjacent green veneers together. In one embodiment, the stitching devices include reciprocating sewing systems that include top and bottom heads that are independently driven by separate servo motors. The use of top and bottom heads that are independently driven allows veneers to be sewn at any desired location along the length of the veneer. In one embodiment, the sewing systems include needles made of hardened steel to ensure the needle can puncture the green veneer. In one embodiment, the top and bottom heads may be auto lubricated to improved needle performance and to ensure the needle remains cool.

The method 500 also includes at block 510 taping of the crowded veneers using one or more veneer quality tape dispenser(s), as described elsewhere herein. One or a plurality of tape dispenser(s) may be provided and configured to apply tape around at least one end of the stitched crowded veneers, as may be understood also with reference to FIG. 7C, described elsewhere herein. The method also includes forming core material by cutting stitched crowded green veneers into a desired dimension, as shown at block 512. In one embodiment, cutting stitched crowded green veneers into a desired dimension includes cutting the continuous sheet of stitched crowded green veneers into sheets of a desired length, such as four feet wide, by a cutting device that is mounted on a carriage that travels in the direction of the veneers at the same rate of that the stitching devices sew to prevent impacts to sewing causing a jam and or needle break. In one embodiment, cutting stitched crowded green veneers into a desired dimension also includes cutting the separate sheets of stitched crowded green veneers into multiple pieces having a smaller length. In one embodiment, the stitched crowded green veneers are cut into sections that are four feet wide and four feet in length. The method 500 concludes at block 514 by drying the core material. In exemplary embodiments, drying the core material includes placing the core material in a drying oven that is configured to reach approximately 500 degrees F. In exemplary embodiments, a thread and/or tape that is utilized by the stitching devices is selected such that the exposure to the conditions of the drying oven does not weaken the strength of the thread and/or tape or cause the thread and/or tape to ignite, i.e., the thread and/or tape is made of a material that has an ignition temperature that is higher than a temperature of the drying oven. The thread and tape may be made from similar or different materials.

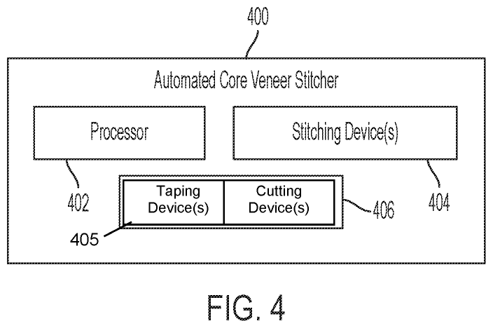

Referring now to FIG. 6 a flow diagram illustrating a method 600 for plywood manufacturing in accordance with an exemplary embodiment is shown. The method 600 begins by placing a face sheet on a conveyor, as shown at block 602. In exemplary embodiments, one or more automated systems are used to place the face sheet onto the conveyor. Next, as shown at block 604, the method 600 includes obtaining core material having stitched core veneers. In exemplary embodiments, the obtaining core material having stitched core veneer is created using a process such as the one shown in FIG. 5. The method 600 also includes placing an adhesive on the face sheet and lay core material onto the adhesive and face sheet. In exemplary embodiments, the core material is placed onto the face sheet such that the grain of the core material is offset from the grain of the face sheet. In one embodiment, the offset is selected to be ninety degrees. In another embodiment, the offset is selected to be forty-five degrees. After the pieces of core material are properly positioned on the face sheet, the conveyor moves the face sheets with the properly positioned pieces of core material through a second glue application station, and an adhesive is applied to an upper surface of pieces of core material, as shown at block 608. Next, as shown at block 610 the method 600 includes placing a back sheet on top of the face sheets and the pieces of core veneer. After the back sheet is placed the loosely assembled plywood panel(s) are placed into a heated press, as shown at block 612.

Referring now to FIGS. 7A and 7B a cross-sectional view and exploded view of plywood 700 manufactured in accordance with an exemplary embodiment are respectively shown. As illustrated, plywood 700 includes a face sheet 702, two pieces of core material 704, and a back sheet 710. The face sheet has a length 712 and width 714 that are the same as the back sheet 710. The pieces of core material 704 have a width 718 that is equal to the width 714 of the face sheet 702 and a length 716 that is half the length 712 of the face sheet 702. In exemplary embodiments, the core material is made of a plurality of veneers 708 that are stitched together by a thread 706. In one embodiment, the face sheet 702 and the back sheet 710 have dimensions of eight feet by four feet, and the core material 704 has a dimension of four feet by four feet. Dimensions of greater than or less than eight and/or four feet may also be provided, for example six by three feet, four by two feet, and otherwise. Each piece of core material 704 includes two continuous stitches of thread 706 that are disposed two inches from the side of the veneers 708. Offset distances may also be greater than or less than two inches, including for example from 0.5″ to up to four inches. In one embodiment, as illustrated, the core material 704 has a grain that is offset from the grain of the face sheet 702 and the back sheet 710 by ninety degrees. Grain offset may also be less than ninety degrees, for example in a range of 45 to 75 degrees and/or approximately 60 degrees. In exemplary embodiments, the two continuous stitches of thread 706 that run across the grain of the veneers 708.

In FIG. 7C a cross-sectional view of the core material 704 of the plywood 700 is also illustrated. In this illustrated and other embodiments, as in FIGS. 7A-B, the core material is made of a plurality of veneers 708 that are stitched together by a thread 706. Overlaying the stitches or thread 706 are respective pieces of tape 707, dispensed by the one or more tape dispensers described previously herein. Although illustrated with tape 707 on both opposing ends, certain embodiments may have tape on only one end, namely that which contains an end string or tail of the stitches provided. In these and still other embodiments, the tape 707 may be wrapped around the top and bottom surface of the core material 704, so as to cover opposing sides of the stitches. It should be understood, though, that the tape may only cover the end and one of the two opposing top and bottom surfaces, as may be desirable in certain scenarios.

Although primarily discussed above with reference to three-ply plywood, those of ordinary skill in the art will appreciate that the methods and systems disclosed herein can be used for constructions that are more than three-ply.

In exemplary embodiments, a system for manufacturing plywood having an automated core veneer crowder and an automated core veneer stitcher can substantially reduce the labor costs associated with manufacturing plywood. In addition, such systems may also increase the speed and efficiency of the plywood manufacturing process, quality, and raw materials utilization. In exemplary embodiments, an automated core veneer crowder may be used to replace an operator that is currently used to crowd individual pieces of core veneer on a veneer conveyor. In exemplary embodiments, the use of an automated core veneer stitcher to join individual pieces of core veneer and to cut the stitched veneers into standard size sheets reduces the labor involved in individually placing the individual pieces of core veneer during manufacturing. In addition, the use of an automated core veneer stitcher to join individual pieces of core veneer increases the strength of the core material.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A method for creating core material, comprising:
receiving a plurality of pieces of green core veneers on a conveyor;
crowding the plurality of pieces of green core veneers by an automated core veneer crowder disposed on the conveyor;
creating a continuous sheet of green core veneers by stitching the crowded plurality of pieces of green core veneers together by an automated core veneer stitcher; and
cutting the continuous sheet of green core veneers into a plurality of sheets of core material that each have a fixed width,
wherein the automated core veneer stitcher is configured to stitch the plurality of pieces of green core veneers at (i) a first location offset a first distance from an outer edge of the plurality of pieces of green core veneers and (ii) a second location offset a second distance from a center of the plurality of pieces of green core veneers, the first and second locations being different relative to one another.

2. The method of claim 1, wherein the automated core veneer stitcher includes a plurality of stitching devices that each include a needle that is configured to puncture holes in each of the plurality of pieces of green core veneers and to pass a thread through the holes.

3. The method of claim 1, further comprising drying the plurality of sheets of core material.

4. The method of claim 2, wherein the thread is made of a material that has an ignition temperature that is higher that a temperature of an oven used to dry the plurality of sheets of core material.

5. The method of claim 1, wherein the automated core veneer stitcher is configured to stitch the plurality of pieces of green core veneers as the plurality of pieces of green core veneers travel on the conveyor at a first rate and wherein cutting the continuous sheet of green core veneers is performed by a cutting device that is mounted to a carriage that travels at the first rate.

6. The method of claim 1, wherein the automated core veneer stitcher includes four stitching devices, two of which are configured to stitch the plurality of pieces of green core veneers at the first distance from the outer edge of the plurality of pieces of green core veneers and two of which are configured to stitch the plurality of pieces of green core veneers at the second distance from the center of the plurality of pieces of green core veneers, the first and second distances being equal.

7. The method of claim 6, further comprising cutting the plurality of sheets of core material at the center of the plurality of pieces of green core veneers.

8. The method of claim 1, further comprising applying tape to at least one end of the stitched continuous sheet of green core veneers to secure the thread against unravelling.

9. The method of claim 8, wherein the tape is applied by a plurality of tape dispensers positioned along the at least one end of the stitched continuous sheet of green core veneers.

10. The method of claim 8, wherein the applied tape is made of a material that has an ignition temperature that is higher that a temperature of an oven used to dry the plurality of sheets of core material.

11. A method for manufacturing plywood having stitched core material, the method comprising:
receiving a face sheet, the face sheet having a grain oriented in a first direction;
applying a first layer of adhesive to the face sheet; placing one or more pieces of stitched core material on the first layer of adhesive, the one or more pieces of stitched core material having a grain oriented in a direction offset at an acute angle from the first direction;
applying a second layer of adhesive to the one or more pieces of stitched core material;
placing a back sheet on the second layer of adhesive; and
pressing the face sheet, the one or more pieces of stitched core material, and the back sheet in a heated press.

12. The method of claim 11, wherein the one or more pieces of stitched core material are formed by:
receiving a plurality of pieces of green core veneers on a conveyor;
crowding the plurality of pieces of green core veneers by an automated core veneer crowder disposed on the conveyor;
creating a continuous sheet of green core veneers by stitching the crowded plurality of pieces of green core veneers together by an automated core veneer stitcher;
cutting the continuous sheet of green core veneers into the one or more pieces of stitched core material that each have a fixed width; and
drying the one or more pieces of stitched core material.

13. The method of claim 12, wherein the automated core veneer stitcher includes a plurality of stitching devices that each include a needle that is configured to puncture holes in each of the plurality of pieces of green core veneers and to pass a thread through the holes.

14. The method of claim 13, wherein the thread is made of a material that has an ignition temperature that is higher that a temperature of an oven used to dry the one or more pieces of stitched core material.

15. The method of claim 13, wherein the automated core veneer stitcher is configured to stitch the plurality of pieces of green core veneers as the plurality of pieces of green core veneers travel on the conveyor at a first rate and wherein cutting the continuous sheet of green core veneers is performed by a cutting device that is mounted to a carriage that travels at the first rate.

16. The method of claim 13, further comprising applying tape to at least one end of the stitched continuous sheet of green core veneers to secure the thread against unravelling, wherein the tape is applied by a plurality of tape dispensers positioned along the at least one end of the stitched continuous sheet of green core veneers.

17. The method of claim 16, wherein the applied tape is made of a material that has an ignition temperature that is higher that a temperature of an oven used to dry the plurality of sheets of core material.

18. The method of claim 13, wherein the automated core veneer stitcher is configured to stitch the plurality of pieces of green core veneers at a first location a first distance from an outer edge of the plurality of pieces of green core veneers and at a second location a second distance from a center of the plurality of pieces of green core veneers, the first location being different than the second location.

19. A piece of plywood comprising;
a face sheet of having a first width, a first length and a grain oriented in a first direction;
a back sheet having the first width, the first length and a grain oriented in the first direction; and
at least two pieces of stitched core material disposed in a single plane between the face sheet and the back sheet, each of the at least two pieces of stitched core material having a grain oriented in a direction offset from the first direction, a length equal to less than half of the first length and a width equal to the first width.

20. The piece of plywood of claim 19, wherein each of the two pieces of stitched core material are formed of multiple pieces of veneers that are joined by at least two rows of stitching that run the length of the core material.

21. The piece of plywood of claim 20, wherein each of the two rows of continuous stitching are disposed no more than two inches from an edge of two the pieces of stitched core material.

22. The piece of plywood of claim 20, wherein at least a portion of the at least two rows of stitching are secured against unravelling by one or more pieces of tape.

23. The piece of plywood of claim 19, wherein the offset is a ninety degree or less offset.

24. The piece of plywood of claim 19, further comprising an adhesive disposed between the face sheet and the two pieces of stitched core material and between the back sheet and the two pieces of stitched core material.
